(19) United States
(12) Patent Application Publication
(10) Pub. No.: US 2008/0198128 A1
(43) Pub. Date: Aug. 21, 2008

(54) KVM SWITCH CAPABLE OF PROVIDING EDID OF DISPLAY FOR COMPUTER COUPLED THERETO AND METHOD THEREOF

(75) Inventors: Tyng-Horng Tsai, Shijr City (TW); Ying-Tsai Huang, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/675,238

(22) Filed: Feb. 15, 2007

(51) Int. Cl. G09G 5/00

(52) U.S. Cl. 345/156; 345/3.1

(57) ABSTRACT

A KVM switch capable of providing real EDID of a display, rather than default EDID, to a computer coupled thereto. The KVM switch includes a processor, at least one memory and at least one switch. The processor queries EDID of the display when the KVM switch is booted and stores the EDID in the memory. The switch couples the computer to the display or the memory to provide the EDID of the display or from the memory to the computer. When the EDID is not available from the memory, the switch couples the computer to the display. When the EDID is not available from the display, the switch couples the computer to the memory. The KVM switch further includes a multiplexer. The multiplexer couples the processor to at least one memory for transferring the EDID of the display to the memory at a time.

### FIELD OF THE INVENTION

The present invention generally relates to a KVM switch and more particularly, to a KVM switch capable of providing EDID of a display for a computer coupled thereto and method thereof.

### BACKGROUND OF THE INVENTION

Generally, a display for a personal computer is directly connected to the computer. When the computer is powered on, it queries EDID of the display through a DDC circuit therebetween. For making display setting of the computer and standard of the display correspond with each other and the best video quality showing on the display, it is necessary for the computer to obtain the EDID queried from the display.

When a console device, including a display, a keyboard and/or a mouse, is coupled to a plurality of computers via a KVM switch, a user of the KVM switch may switch to one of the computers to remote the computer and monitor the video of the computer on a display of the console. However, the computer cannot query EDID of the display of the console due to the KVM switch inbetween. According to prior arts, a KVM switch may pre-stores default EDID when the computer is powered on and queries EDID, the KVM switch disregards the standard of the display but only provides the default EDID to the computer. Generally, the default EDID provided by the KVM switch is different from the real EDID of the display, and thus some problems arise.

As well known, the resolution of the computer is adjustable. However, for example, the supportable highest resolution of the default EDID is 1024×768 pixels but the supportable highest resolution of the display is 1280×1024 pixels. In control menu of the computer's OS, the supportable highest resolution can be seen is 1024×768 pixels. Even the resolution of the computer can be adjusted to 1280×1024 pixels, the display is still showing the video with resolution 1024×768. If the resolution of the computer is adjusted to 800×600 pixels, the video of the computer may not be shown normally, or even may not be received by the display.

Another example is that the supportable highest resolution of the default EDID is 1024×768 pixels but the supportable highest resolution of the display is 800×600 pixels. If the resolution of the computer is adjusted to 1024×768 pixels, the video of the computer may cause damage to the display.

Furthermore, some KVM switch may not pre-store default EDID, especially mentioning about some cheap KVM switch. For purpose of cost down, such KVM switch omits the memory for pre-storing the default EDID. Accordingly, the computers coupled to such KVM switch are forced to use the default EDID thereof. For example, no matter what the supportable highest resolution of the display is, the video showing on the display is limited by the supportable highest resolution of the default EDID of the computer.

The KVM switch of the present invention providing real EDID from the display for computers coupled thereto can resolve drawbacks of prior arts.

### SUMMARY OF THE INVENTION

An objective of the present invention is to provide a KVM switch capable of providing EDID of a display to a computer coupled thereto and method thereof.

Another object of the present invention is to provide a KVM switch showing video of the computer coupled thereto on a display with real resolution.

The KVM switch of the present invention comprises a processor, at least one memory and at least one switch. The processor is coupled to the display for querying first EDID of the display after the KVM switch is booted. The processor stores the first EDID in the memory. The switch couples the computer to the display or the memory to provide the first EDID of the display or from the memory to the computer when the computer queries the first EDID, i.e. during the computer is booting. When the first EDID is available from the memory, the switch couples the computer to the memory. When the first EDID is not available from the memory, the switch couples the computer to the display. The KVM switch of the present invention further comprises a multiplexer. The multiplexer couples the processor to more than one memory to transfer the first EDID to the memories. In this way, the processor provides only one I/O pin for transferring the first EDID to at least one memory.

The memory may further comprise a second EDID stored therein. When the first EDID is available neither from the display nor from the memory, the KVM switch provides the second EDID stored in the memory to the computer.

The present invention further provides a method of providing the first EDID for at least one computer coupled to a KVM switch. The method comprises steps as described below:

querying the first EDID of a display;

storing the first EDID into at least one memory after the KVM switch is booted; and

coupling the computer to the display or the memory to provide the first EDID to the computer when the computer queries the first EDID.

The KVM switch of the present invention can provides first EDID of a display to the computer coupled thereto. The computer obtains the first EDID of the display, therefore, capable of showing video of the computer on the display with real resolution.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a block diagram of a KVM switch having a multiplexer for transferring a first EDID that the processor queries from a display to the memories according to first embodiment of the present invention;

FIG. 2 shows a block diagram of a KVM switch, which the processor has enough I/O pins for coupling to the memories according to second embodiment of the present invention;

FIG. 3 shows a block diagram of a KVM switch, which the processor embedding a memory inside for storing the first EDID according to third embodiment of the present invention; and

FIG. 4 shows a flow chart of the method of providing first EDID for at least one computer coupled to a KVM switch according to the present invention.

### DETAILED DESCRIPTION OF THE INVENTION

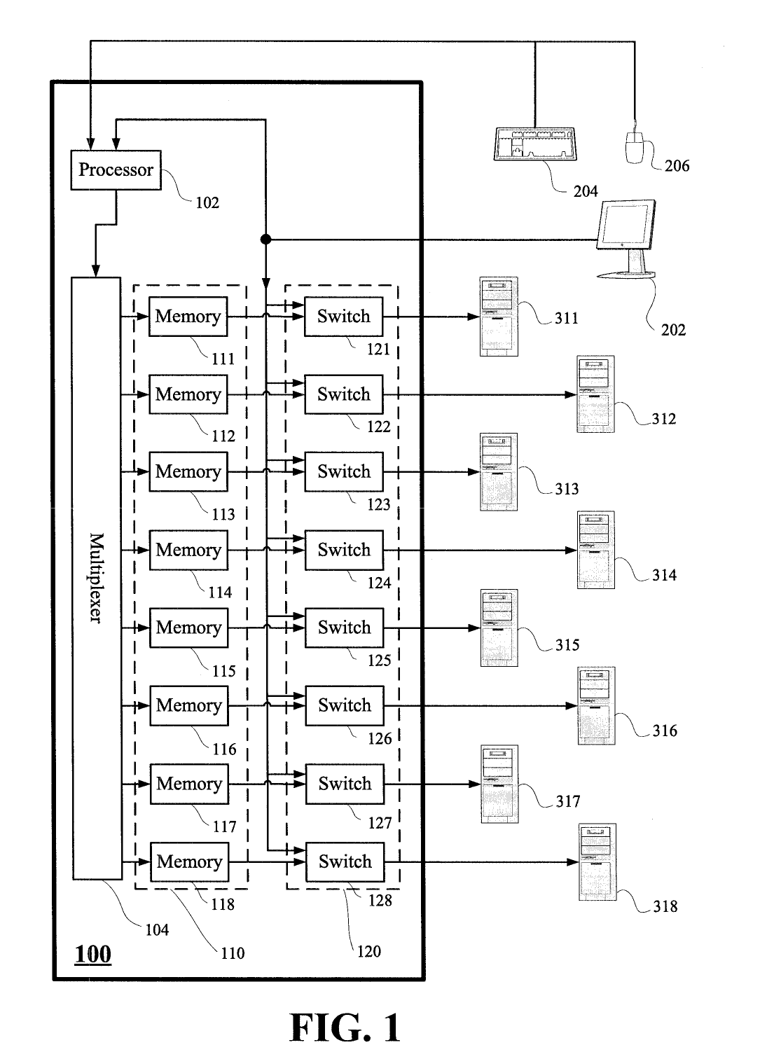

Please refer to FIG. 1, which shows a block diagram of a KVM switch 100 according to first embodiment of the present invention. A console device, which may include a display 202, a keyboard 204 and/or a mouse 206 is coupled to a plurality of computers, such as eight computers 311 to 318, via the KVM switch 100. In this embodiment, the KVM switch 100 includes a processor 102, a multiplexer 104, eight memories 111 through 118 and eight switches 121 through 128. Please note that the number of the memories correspond to the number of computes, and are not limited to eight. The multiplexer 104, the memories 111 through 118 and the switches 121 are controlled by the processor 102. The display 202 is coupled to the processor 102. The processor 102 may have a plurality of I/O pins but due to a large amount of devices, which the processor 102 has to control, generally, the processor 102 provides only one I/O pin for dealing with first EDID, therefore, the multiplexer 104 is required to couple the I/O pin of the processor 102 to the memories 111 through 118 for transferring the first EDID of the display 202 to one of the memories 111 through 118. The switches 121 through 128 couple the eight memories 111 through 118 to the computers 311 through 318, respectively.

When the KVM switch 100 is booted, the processor 102 queries a first EDID of the display 202. Then the processor 102 delivers the first EDID to the multiplexer 104. The multiplexer 104 transfer the first EDID that the processor 102 queries from the display 104 to the memories 111 through 118. That is, after booting, the KVM switch 100 stores the first EDID of the display 202, in the memories 111 through 118. The KVM switch 100 can store the first EDID, of the display 202, in the memories 111 through 118 sequentially or randomly. When the computers 311 is powered on and queries the first EDID, the processor 102 determines if the first EDID is available from the memory 111. If the first EDID is available, the switch 121 couples the computer 311 to the memory 111 to let the computer 311 obtain the first EDID from the memory 111. On the other hand, if the first EDID is not available from the memory 111, the switch 121 couples the computer 311 to the display 202 to let the computer 311 obtain the first EDID from the display 202.

Similarly as describing about when other seven computers 312 to 318 are powered on and query the first EDID.

Although booting of KVM switch 100 may only take several seconds, it is still possible that the processor 102 is querying the first EDID of the display 202 but the multiplexer 104 has not transferred the first EDID to all the memories 111 through 118 yet. For example, the multiplexer 104 has transferred the first EDID to the memories 111 through 113 and is going to transfer the first EDID to the memory 114. At this moment, the computers 318 is powered on and queries the first EDID to the KVM switch 100, therefore, the first EDID is not available from the corresponding memory 118 but the switch 125 is coupling another computer 315 to the display 202 for querying the first EDID of the display 202. Consequently, the computer 318 cannot obtain any first EDID. Specifically, the switches 121 through 128 also may be replaced by a crosspoint switch (represented by the broken line block 120 shown in FIG. 1), which has multiple inputs and multiple outputs, such as, the AD8108/AD8109 provided by ANALOG DEVICES COMPANY. Similarly, the memory 111 through 118 also may be replaced by a memory (represented by the broken line block 110 shown in FIG. 1), which has a plurality of I/O pins to simplify the circuit inside the KVM switch 100.

Therefore, each of the memories 111 through 118 of the KVM switch 100 may further comprise a second EDID stored therein. When the first EDID is available neither from the display 202 nor from the memories 111 through 118, the processor 102 can control the switches 121 through 128 still to couple to the memories 111 through 118 but provide the second EDID stored therein to the computers 311 through 318. The memories 111 through 118 may be non-volatile memories. Alternatively, the second EDID may be a pre-saved EDID prepared by the manufacturer of the KVM switch 100 or a last first EDID stored when the KVM switch is booted last time.

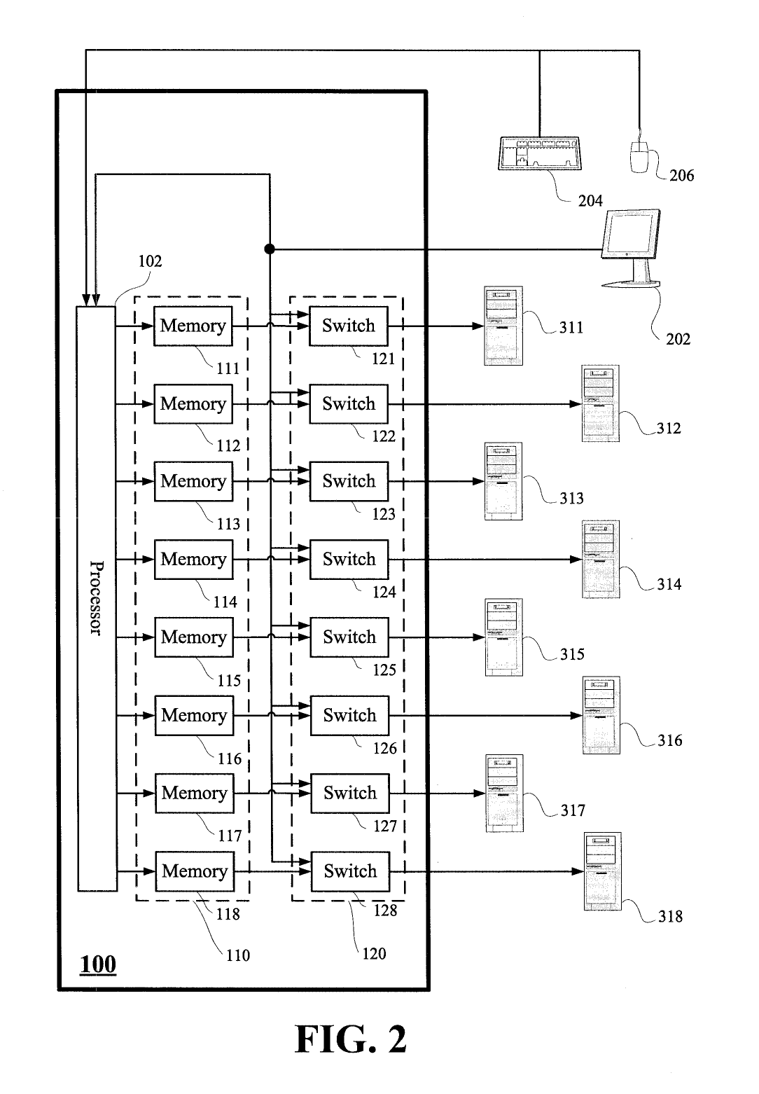

Please refer to FIG. 2 with FIG. 1. FIG. 2 shows a block diagram of a KVM switch 100, in which the processor 102 provides more than one I/O pins coupled to the memories 111 through 118 according to second embodiment of the present invention. In this embodiment, the processor may contribute eight I/O pins for the eight memories 111 through 118, therefore, a multiplexer 104 for transferring the first EDID shown in FIG. 1 can be omitted for simplifying the circuit inside the KVM switch 100 and decreasing the cost about elements. Specifically, the switches 121 through 128 also may be replaced by a crosspoint switch (represented by the broken line block 120 shown in FIG. 2), which has multiple inputs and multiple outputs, such as, the AD8108/AD8109 provided by ANALOG DEVICES COMPANY. Similarly, the memory 111 through 118 also may be replaced by a memory (represented by the broken line block 120 shown in FIG. 2), which has a plurality of I/O pins to simplify the circuit inside the KVM switch 100.

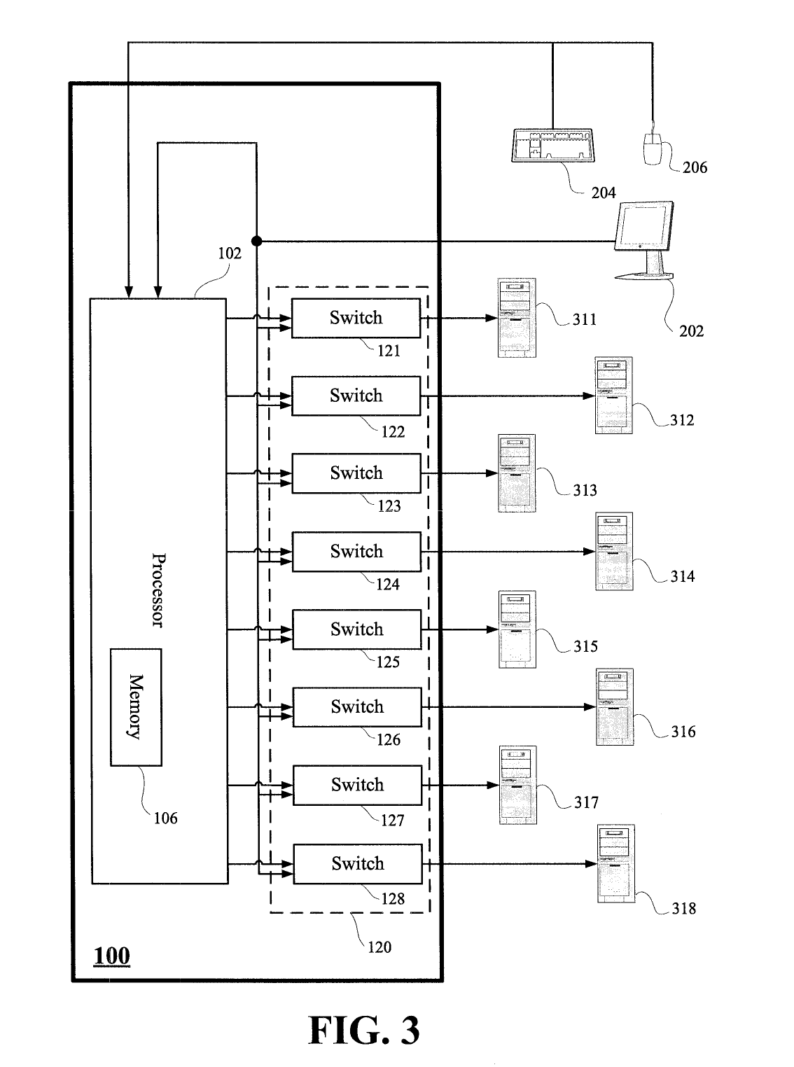

Please refer to FIG. 3 with FIG. 2. FIG. 3 shows a block diagram of a KVM switch 100, in which the processor 102 embedding a memory 106 inside for storing the first or the second EDID according to a third embodiment of the present invention. In this embodiment, the processor may be a SoC (System on Chip) embedding a memory 106, accordingly, the eight memories 111 through 118 shown in FIG. 1 and FIG. 2 can be omitted for further simplifying the circuit inside the KVM switch 100 and decreasing the cost about elements more. Specifically, the switches 121 through 128 also may be replaced by a crosspoint switch (represented by the broken line block 120 shown in FIG. 3), which has multiple inputs and multiple outputs, such as, the AD8108/AD8109 provided by ANALOG DEVICES COMPANY.

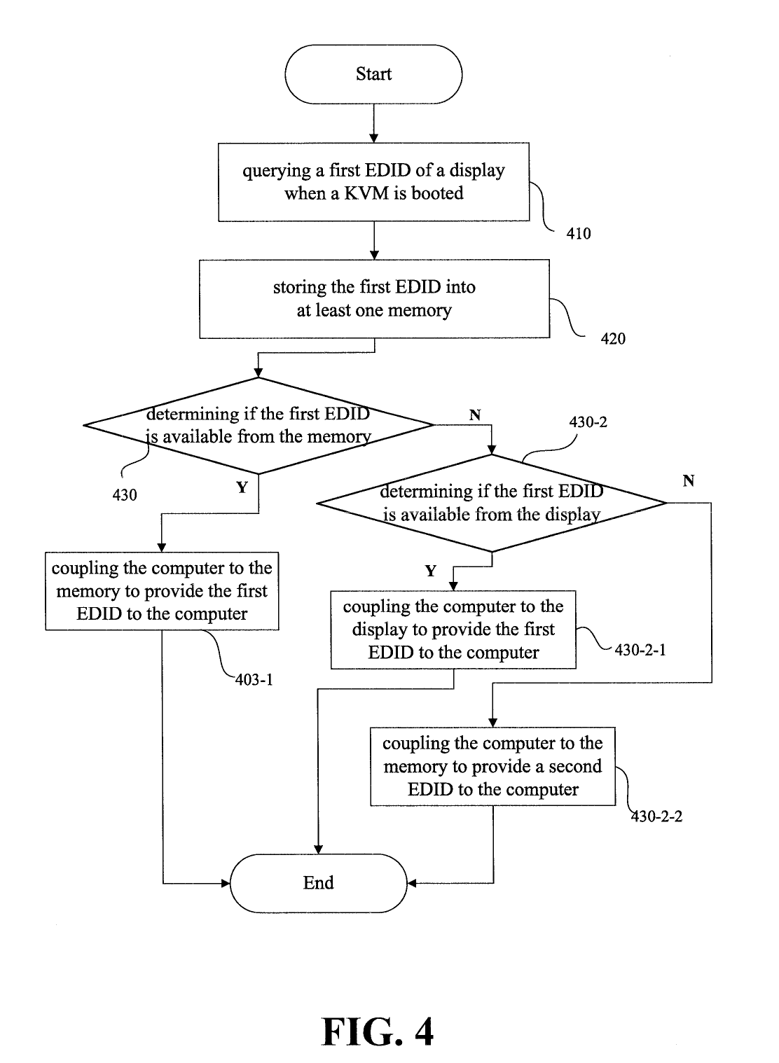

Please refer to FIG. 4 which shows a flow chart of the method of providing first EDID of the display for the computers coupled to a KVM switch according to the present invention. For accomplishing the objective of the present invention, the method of the present invention includes the steps below:

In step 410, querying a first EDID of a display when the KVM is booted;

In step 420, storing the first EDID into at least one memory;

In step 430, determining if the first EDID is available from the memory;

In step 430-1, the first EDID is available, then coupling the computer to the memory to provide the first EDID to the computer;

In step 430-2, the first EDID is not available, then determining if the first EDID is available from the display;

In step 430-2-1, the first EDID is available, then coupling the computer to the display to provide the first EDID to the computer; and

In step 430-2-2, the first EDID is available neither from the display nor from the memory, then coupling the computer to the memory to provide a second EDID.

If the first EDID is available, the switch 121 couples the computer which is booting, such as the computer 311, to one of the memory, such as the memory 111, to let the computer obtain the first EDID from the memory. On the other hand, if the first EDID is not available from the memory 111, the switch 121 couples the computer 311 to the display 202 to let the computer 311 obtain the first EDID of the display 202.

According to the KVM switch of the present invention, providing the real EDID of the display for the computer coupled thereto can be realized. With the real EDID, the computer can be adjusted to its preferred resolution that matches the supportable resolution or the highest resolution of the display for showing the video of the computer on the display

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A KVM switch coupling at least one computer to a display, the KVM switch comprising:
a processor, coupled to the display, querying a first EDID of the display;
at least one memory, storing the first EDID after the KVM switch is booted; and
at least one switch, coupling the computer to the display or the memory to provide the first EDID of the display or from the memory to the computer when the computer queries the first EDID.

2. The KVM switch according to claim 1, wherein the switch couples the computer to the memory when the first EDID is available from the memory.

3. The KVM switch according to claim 1, wherein the switch couples the computer to the display when the first EDID is not available from the memory.

4. The KVM switch according to claim 1, further comprising a multiplexer, coupling the processor to at least one memory and transfer the first EDID to the memory.

5. The KVM switch according to claim 1, wherein the memory is a non-volatile memory.

6. A KVM switch coupling at least one computer to a display, the KVM switch comprising:
a processor, coupled to a display, querying a first EDID of the display after the KVM switch is booted;
at least one memory, having a second EDID stored therein, and further storing the first EDID after the KVM switch is booted; and
at least one switch, coupling the computer to the display or the memory to provide the first EDID or the second EDID to the computer when the computer queries the EDID.

7. The KVM switch according to claim 6, wherein the switch couples the computer to the display when the first EDID is not available from the memory.

8. The KVM switch according to claim 8, wherein the switch couples the computer to the memory to provide the second EDID to the computer when the first EDID is available neither from the display nor from the memory.

9. The KVM switch according to claim 6, further comprising a multiplexer, for coupling the processor to at least one memory, and transfer the first EDID of the display to the at least one memory.

10. The KVM switch according to claim 6, wherein the memory is a non-volatile memory.

11. A KVM switch coupling at least one computer to a display, the KVM switch comprising:
a processor, coupled to the display, querying a first EDID of the display;
a memory, storing the first EDID after the KVM switch is booted; and
a switch;
wherein if the first EDID is not available from the memory when the computer is booting, the switch couples the computer to the display to let the computer obtain the first EDID of the display.

12. The KVM switch according to claim 11, wherein the switch is a corsspoint switch.

13. A method of providing a first EDID for at least one computer coupled to a KVM switch, the method comprising steps of:
querying the first EDID of a display;
storing the first EDID into at least one memory after the KVM switch is booted; and
coupling the computer to the display or to the memory to provide the first EDID to the computer when the computer queries the first EDID.

14. The method according to claim 13, further comprising a step of determining whether the first EDID is available from the memory of the KVM switch when the computer queries the first EDID before the coupling step.

15. The method according to claim 14, wherein, if the first EDID is available, the coupling step is coupling the computer to the memory to provide the first EDID.

16. The method according to claim 14, wherein, if not, the coupling step is coupling the computer to the display to provide the first EDID.

17. The method according to claim 14, wherein the memory further comprises a second EDID stored therein.

18. The method according to claim 17, during the determining step, further determining if the first EDID is available from the display when the computer queries the first EDID.

19. The method according to claim 18, if the first EDID is available neither from the display nor from the memory, the coupling step is coupling the computer to the memory to provide the second EDID.
